(19) United States
(12) Patent Application Publication
(10) Pub. No.: US 2023/0351278 A1
(43) Pub. Date: Nov. 2, 2023

(54) TASK TRACKING TOOL

(71) Applicant: Clean Claims IP, LLC, Bluffdale, UT (US)

(72) Inventor: Lane Larsen, Bluffdale, UT (US)

(73) Assignee: Clean Claims IP, LLC, Bluffdale, UT (US)

(21) Appl. No.: 18/141,582

(22) Filed: May 1, 2023

Related U.S. Application Data
(60) Provisional application No. 63/336,727, filed on Apr. 29, 2022.

(51) Int. Cl. G06Q 10/0631

(52) U.S. Cl. CPC G06Q 10/063114; G06Q 10/06315

(57) ABSTRACT

Systems and devices for workflow tracking are provided that include receiving a request to initiate a project along with information about the type of project and generating suggested tasks according to the type of project initiated. The task tracking method is involved in receiving acceptance or denial of the suggested tasks and storing information about a project and the tasks required to complete the project in a plurality of network-based non-transitory storage devices having a collection of projects stored thereon. Moreover, the method comprises providing remote access to users over a network so any one of the users can update the information about the project's progression in real time through a graphical user interface, wherein the one of the users provides the updated information on a device associated with the user displaying the graphical user interface. Further the method incorporates storing the updated information about the project's progression in the collection of projects and automatically generating a message containing the updated information about the project by the content server whenever updated information has been stored. Transmitting the message to one or more select users over the computer network in real time, the one or more select users has immediate access to up-to-date project information, and converting, by a content server the collected information into a report is also part of the task tracking method.

This application claims the priority and benefit of U.S. Provisional Patent Application No. 63/336,727, filed on Apr. 29, 2022, which is incorporated herein, by reference.

### TECHNICAL FIELD

### Technical Field

The disclosure relates generally to systems, methods, and devices for a task-tracking tool and particularly relates to computer implementations for project task tracking.

### Background

Various industries and business models utilize workflows for organizing tasks and tracking progress on various workflow tasks. In certain industries, workflows can be exceedingly complex and may include many tasks that may be impacted by various conditions. A plurality of persons and entities may be interested in the progress of one or more of the workflow tasks and may benefit from receiving an automatic update on workflow progress in real-time.

Completing a project can become complicated. The path to completing a project may change as different obstacles arise and different unknown variables become known. This process becomes more complicated as more people become involved. The complexity increases with an additional party that has additional requirements to complete the project. To increase the difficulty of the process each party and person involved may require updates as the process unfolds. Further, an update for one party may be irrelevant to the next party. Moreover, the additional requirements may need to be completed chronologically. Tasks may need to be completed chronologically to meet the obligations of all parties involved. Likewise, state or federal regulations in an industry may further add additional obligations to the project.

Systems, methods, and devices disclosed herein provide automatic task-tracking tools. Such task-tracking tools may be used to navigate the complexities of the project requirements for all parties involved. Further, the work tracking tool may provide certain requirements to satisfy all parties involved. Sensors may be involved to provide data to the tracking tool that then may be communicated to other parties involved.

### SUMMARY

Disclosed herein is a task tracking method that includes receiving a request to initiate a project along with information about the type of project and generating suggested tasks according to the type of project initiated. The task tracking method is involved in receiving acceptance or denial of the suggested tasks and storing information about a project and the tasks required to complete the project in a plurality of network-based non-transitory storage devices having a collection of projects stored thereon. Moreover, the method comprises providing remote access to users over a network so any one of the users can update the information about the project's progression in real time through a graphical user interface, wherein the one of the users provides the updated information on a device associated with the user displaying the graphical user interface. Further the method incorporates storing the updated information about the project's progression in the collection of projects and automatically generating a message containing the updated information about the project by the content server whenever updated information has been stored.

Transmitting the message to one or more select users over the computer network in real time, the one or more select users has immediate access to up-to-date project information, and converting, by a content server the collected information into a report is also part of the task tracking method.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. The advantages of the present disclosure will become better understood with regard to the following description and accompanying drawings:

FIG. 1 illustrates an example of a user interface of a task tracking tool, according to an embodiment of the disclosure.

FIG. 2 illustrates an example of a user interface of a task tracking tool, according to an embodiment of the disclosure.

FIG. 3 illustrates an example of a user interface of a task tracking tool, according to an embodiment of the disclosure.

FIG. 4 illustrates an example of a user interface of a task tracking tool, according to an embodiment of the disclosure.

FIG. 5 illustrates an example of a user interface of a task tracking tool, according to an embodiment of the disclosure.

FIG. 6 illustrates an example of a user interface of a task tracking tool, according to an embodiment of the disclosure.

FIG. 7 illustrates an example of a user interface of a task tracking tool, according to an embodiment of the disclosure.

FIG. 8 illustrates an example of a task-tracking tool system according to an embodiment of the disclosure.

FIG. 9 illustrates a schematic diagram of an exemplary system for a task-tracking tool, according to an embodiment of the disclosure.

FIG. 10 illustrates an example of a method of a task tracking tool.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

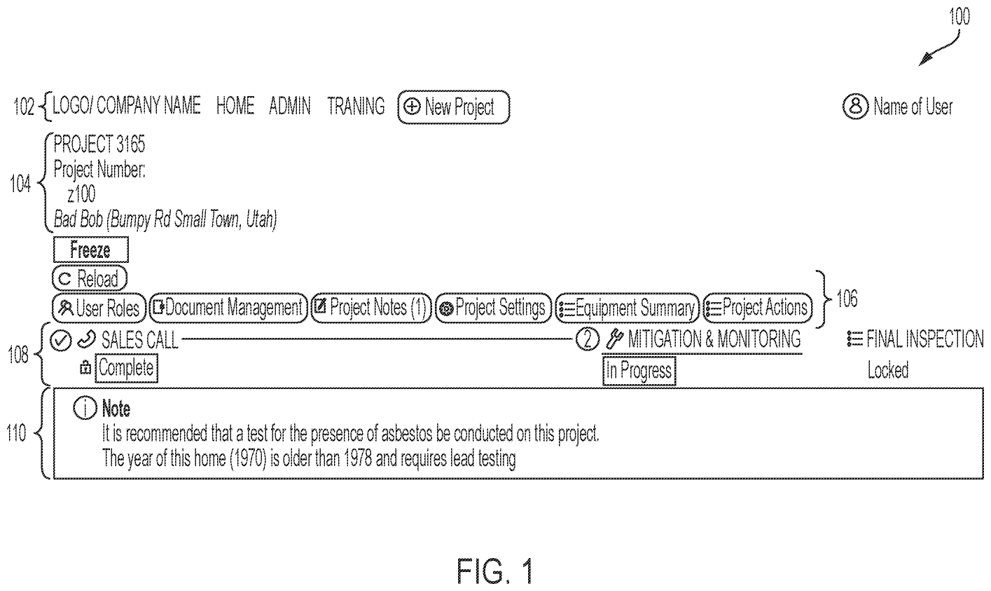

FIG. 1 illustrates an example of a user interface of task tracking tool 100. Task tracking tool 100 may include menu 102. Menu 102 may include a logo input by the user or administrator and or the name of the user. Menu 102 may further include an option including one or more home, admin, training, and adding a new project. Admin options may include the ability to set up a business platform, and logo and to adjust access of one or more users. Under the Admin tab, a user may adjust the communication level for each person and or party involved in the project. For example, if the project includes a damage repair of a home the parties involved may include a contractor, subcontractor, insurance adjustor, renter, property management member, owner, inspector, and/or law enforcement. Each of these people or parties may likely require different information and or notifications. For instance, a law enforcement officer may only want to know the overall value of what was lost and, alternatively, a renter would like to know when the damage will be fixed. An inspector may want to know when rewiring is complete while an owner wants to know when the whole project will be completed and the cost to finish the project. Accordingly, under the admin option of menu 102, a user may choose which information is to be shared with the parties or persons involved.

Under the training tab of menu 102, a user may watch videos that provide instructions on how to use task tracking tool 100. For example, a user may learn how to add a new project or how to adjust the communication level with different users. The training videos may be divided into different sections to be more palatable to the user. The training videos may describe one or more steps included in the task tracking tool 100. There also may be a rewards program for completing the videos and may even include one or more quizzes at the end of the videos. Also in menu 102, an option to add/create a new project is provided. This option allows the user to track the progress of one or more projects at the same time.

Project information 104 may be listed on the user interface of task tracking tool 100. Project information may include a name of the project, a number of the project, a project address, a project manager, a project type, a project owner, and other identifying information. Each of these elements may be located on the user interface of task tracking tool 100 and may be adjusted according to a specific user. For example, a subcontractor may be able to log in and monitor the progress of one or more tasks but may not be provided with an additional new project option or an admin option under menu 102.

The user interface of task tracking tool 100 may include a project menu 106. This project menu 106 may include a user roles tab, a document management tab, a project notes tab, a project settings tab, an equipment summary tab, and project actions. Selecting the user role tab in project menu 106 may allow the administrator or user to add a user and select, according to the user, a certain level of access to the task tracking tool 100. The projects note tab in project menu 106 allows various users to keep notes throughout the process about a certain project or task at a particular location. An administrator or user may selectively allow another user to see and/or add notes to the project notes tab. Also, the notes tab of project menu 106 may indicate the number of notes available on the tab. Further, notes may include an audio-to-text feature within the notes tab or in other locations of the user interface.

The project settings tab found in project menu 106 may allow an administrator or an authorized user to outline the requirements for a particular project. Certain adjustable default requirements may be preselected before opening the tab. The requirements for the project may be selected and/or deselected which in turn adjusts the required tasks needed for the completion of the project. Furthermore, the selected project requirements may create task that require completion before the user can proceed to the next step or next task. For example, one or more requirements may include, requiring a health survey or making project notes visible to others. Also, the adjustable default requirements may include equipment information, scope information, initial sensor readings, or subsequent sensor readings. Other default requirements may include before and after videos, before and after images, thermal images, equipment, and images of sensor readings. When a video is uploaded, a timestamp may be included for each task to be shown in the final report. Changes to the product settings may be saved and may, subsequently, add task which may require completion the user can proceed to the next step.

The equipment summary tab in project menu 106 may provide a list of the type of equipment. The equipment summary tab in project menu 106 also may list under each equipment item associated with the project whether or not the equipment has been picked up and what equipment has yet to be picked up. It also may provide the total number of equipment requested. The project menu 106 may also include project actions where a user can download different documents associated with the project. Documents associated with the project may include, for example, a full report, a contract, a certificate of completion, sensor readings, an equipment list, photos, and archived projects.

Stage banner 108 may be included in listing stages of a project which are necessary to complete the project. The stage banner may also include status indicators. For example, if one stage is complete the stage may indicate that particular stage is complete by a color associated with a complete stage. If a stage has yet to be completed the stage may include an in-progress indicator. Finally, if a stage has not been started, the stage may include a locked indicator status. These stages may be set to prohibit progress to the next stage until all tasks are completed in a prior stage. In so doing, all tasks are more likely to be completed if barred from progress until one stage is completed in its entirety. The indicator may display how many tasks are completed and how many tasks are outstanding as an overview of the whole project. This may also be used to indicate how many subtasks are needed to complete a task.

Task tracking tool 100 may include note banner 110 displaying information. Whether or not note banner 110 is included may be determined by the system (or authorized user) and displayed for the user based on input by the user at the start of a project. Displaying note banner 110 may be determined if the data input by the user triggers additional caution that may implicate state and/or federal requirements. For example, if a project includes repair of a house in California constructed in 1970 a note banner 110 may be displayed to the user and may include a warning of the possible presence of asbestos and lead paint that may require additional protocol to satisfy federal and California state rules and regulations. Note banner 100, displaying protocol required, may be selected by the system (or authorized user) based on geographic location, year of construction, materials used in original construction, materials used in repair, type or intensity of damage, type of event that triggered the need for repair, or other factors known in the art that may implicate federal and/or state laws, rules, or regulations. What factors or information about the project that triggers note banners may be adjusted by the system or authorized user. Further, who views note banner 110 may also be adjusted by the system or authorized user to be displayed on devices associated with the users who need to be aware of the protocols required.

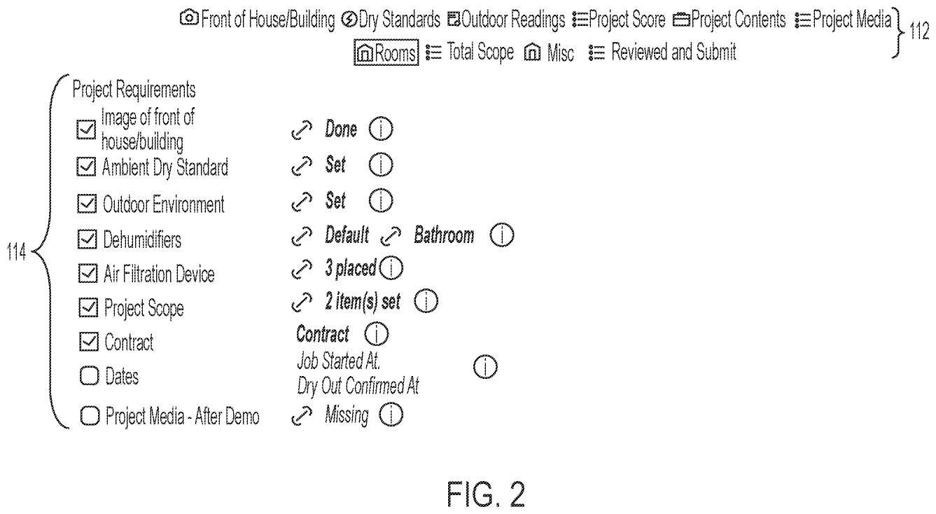

FIG. 2 illustrates an example of a user interface of task tracking tool 100. Tracking tool 100 may include a table of contents tabs 112. Table of contents 112 may include one or more project requirement tabs which, when selected, cause the user interface to display information used to satisfy the project requirements. If no information has been input, the user interface may allow a user to provide input. For example, if one of the requirements is a picture of the front of a building a user may select the requirement and a picture of a front of a building may be displayed. Or, if a picture has yet to be uploaded the user interface may include an icon inviting the user to upload a picture. If the project is body work on an automobile, for example, task management tool 100 may require a “before” picture of the vehicle which is a picture of the vehicle before work is performed. The user may select the before picture of the vehicle and the vehicle picture may be displayed to help orient the user to the appropriate project. When a user uploads a image the name of the user and the time stamp of the uploaded image. The name of a user and a time stamp may be used when any information is uploaded and when any task is completed.

Broadly speaking the project requirements may include information about the project prior to starting, information about the project in progress, and information about the project upon completion. Even though these examples pertain to house project task tracking tools may track any project that requires a plurality of tasks. The respective projects may also include industry standards for respective projects along with the requirements to meet the expectations of the parties involved. Further, the user interface may include a checklist 114 displayed for the user to visualize what has been completed and to make note of what projects have yet to be completed. The checklist may include, images of the project, project standards, industry standards, equipment needed, project scope, contract, dates, and project media. Requirements to move to the next stage of the project may also be provided in checklist 114.

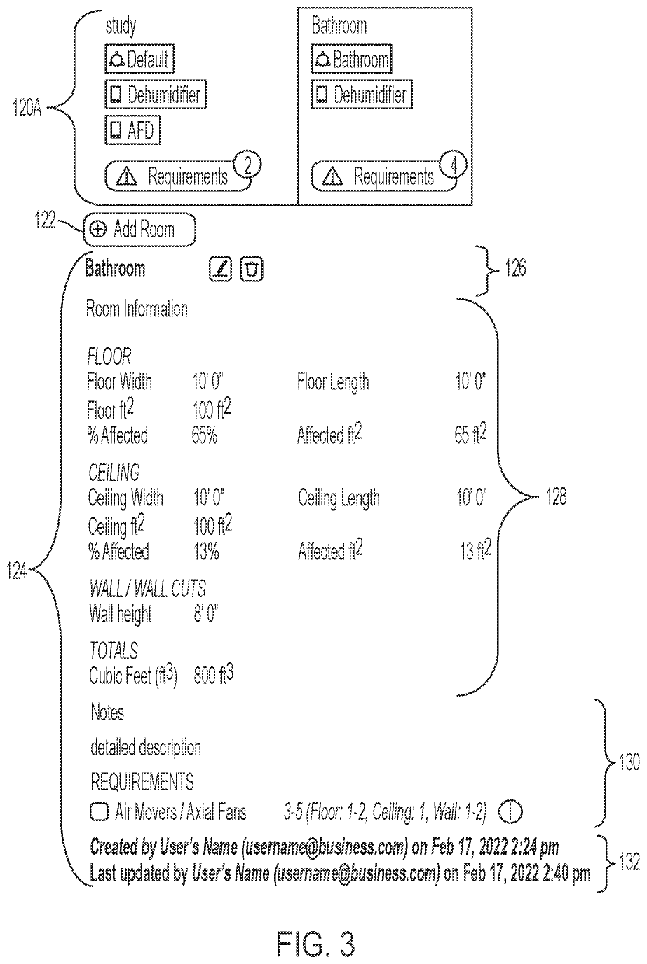

FIG. 3 illustrates an example of a user interface of task tracking tool 100. FIG. 3 illustrates an interface that includes an additional room tab 122 where the user can select to add a room or a room/area where at least one of the tasks in the project is to take place. If the project involves bodywork on an automobile, for example, an area may include an identification of a panel that has been damaged. The size of a certain panel may be precalculated based on the year and the model of the vehicle. Additionally, the size of the panel area may be included. Length and the width of an area may be input, and the square footage may be calculated by the task tracking tool. Furthermore, a user may input a percentage of a room or area in need of repair. Also, depending on the type of repair needed different questions may be prompted. Different areas of the room/area may be affected differently. If the project includes a repair for water damage in a house, areas of input may include floors, walls, and ceilings. After a user inputs the size of the floor manually or, by a sensor, a square footage is calculated by task tracking tool 100. An option may be included to allow the user to select the ceiling area to be the same area as the floor. If the ceiling is the same length and width as the floor the calculated size of the floor is input and the area of the ceiling may be calculated by task tracking system 100. Also, once the percentage of ceiling damaged is input the square footage is therefore adjusted. Once a user has selected a room/area, room/area details 124 may be displayed on the user interface.

Room/area details 124 may include room name 126, room/area dimensions 128, and other requirements 130. Additionally, room/area details may include user indicator 132. Room/area details may include the square footage of the area, the percentage affected, and the total area affected. Other requirements 130 may include notes added by the user that might indicate how extensive the damage may be and the progress of the tasks. Other requirements 130 may include a detailed description not otherwise easily described e.g., the smell of the area and the relative wetness of the floor. Moreover, requirements 130 may include equipment or other requirements indicated because of the damage as calculated. Some of these requirements may include certain equipment. As a result, new tasks may be created under requirements 130.

Furthermore, equipment used for a particular task or stage may be included to help organize and distribute the equipment most effectively. For example, based on the calculation of the area of water damage, the system may suggest a certain number of fans or dehumidifiers to ensure adequate drying over the calculated area. If more fans are placed in the study than the number of fans suggested by the system, the extra fans could be relocated to the bedroom.

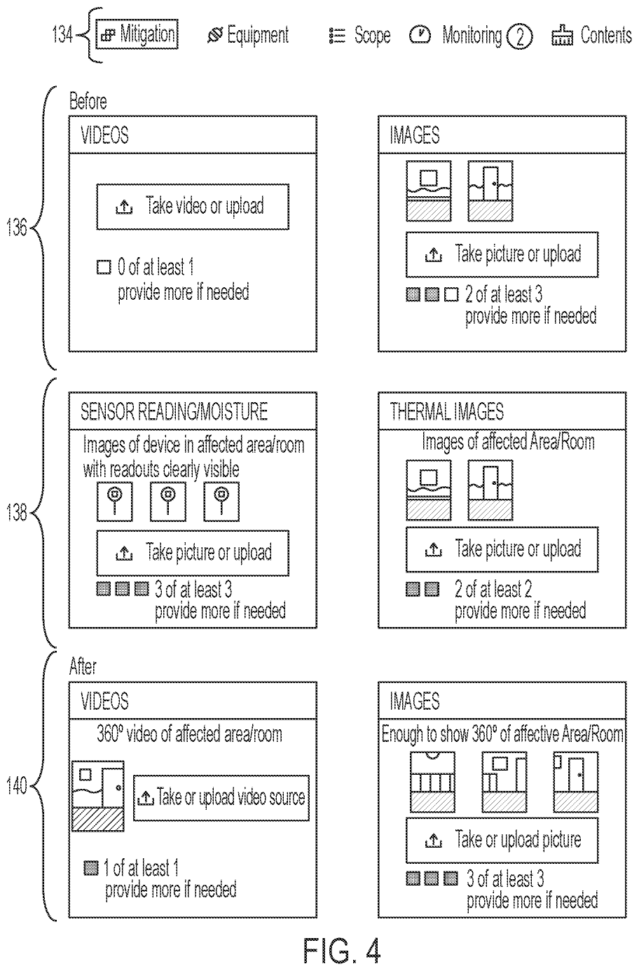

FIG. 4 illustrates an example of a user interface of task tracking tool 100, according to an embodiment of the disclosure. Room menu 134 may include tabs such as mitigation, equipment, scope, monitoring, and contents. These tabs may be populated based on the details input when add room 122 is selected, as shown in FIG. 3. When mitigation is selected before tasks 136, sensor tasks 138, and after tasks 140 may be displayed. Before tasks 136 may require that at least one video be taken prior to commencing mitigation. Before tasks 136 may also require one or more photographs to be taken of the affected area before mitigation continues. These photographs and videos may be uploaded from a digital device or may be taken by the device and input directly if using a device with photographic capabilities. A visual indication of how many photographs, videos, and sensor data have been uploaded may be displayed. This display may readily show to a user how many tasks have been completed.

The task tracking tool 100 may include requirements for the number of media or sensor entries. For example, task tracking tool 100 may require at least one video before commencing mitigation and/or 3 or more pictures showing the affected area before mitigation. The same requirements may be included for sensors before commencing mitigation. If the project were a vehicle, the same or similar requirements may be included. Sensor tasks 138 may include sensor reading of the affected area. The task tracking tool 100 may have the ability to connect to sensors either with wires or wirelessly to receive sensor input. Sensor task 138 may require a certain number of sensor readings. A baseline reading from one or more sensors may be required for relative levels of certain elements (e.g., water, lead, drug contamination, etc.) in an unaffected room/area may be required. Also, before mitigation one or more sensor readings may be required to be taken at the affected area. Various sensors may be used (e.g., a moisture sensor, a thermal imaging sensor, a temperature sensor, a water sensor, cameras, and other sensors known in the art). Task tracking tool 100 may require one or more photographs of the sensor reading provided by the sensor. The photographic evidence may not be required if the sensor is able to communicate directly to task tracking tool 100. Furthermore, sensor readings may be required throughout the process, including before, during, and after the project has been completed.

After data 140 may also be included in task tracking tool 100. After data may include a task requirement that includes one or more videos taken of the affected room/area. Multiple videos may be taken to show the complete area or to adjust for bad lighting in a certain area. After data 140 may also include an input area on the display to upload a photograph. An uploaded photograph may be a part of the task requirement that is required to complete the mitigation portion of the project. The user interface displayed in FIG. 4 allows all parties who are given access to see the progress that has taken place throughout the entirety of the process through photographs and videos. A certain number of photographs or videos may be required. Also, a visual indication of how many videos or photographs have been uploaded may be included. Once a video or a photograph has been uploaded, a thumbnail of the video or photograph may be created in one or more task boxes on display. Also, there may be windows that fill in or are checked after uploading a video. Further, photograph or sensor readings may be included in the windows to graphically illustrate how many videos/photographs are yet required.

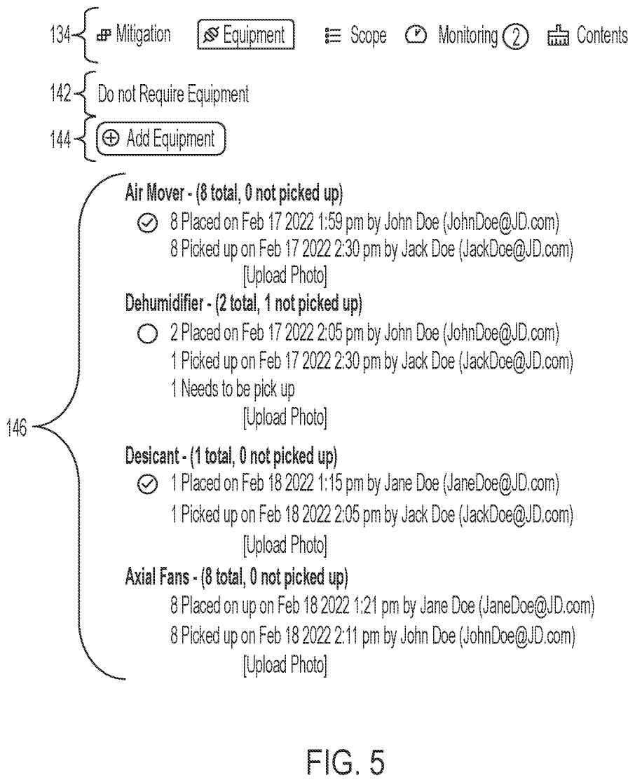

FIG. 5 illustrates an example of a user interface of task tracking tool 100, according to an embodiment of the disclosure. The equipment tab under room menu 134 when selected may display an option for a equipment requirement tab 142 where an administrator or other authorized user can add or remove the requirement for equipment. Depending on the type of project submitted, task tracking tool 100 may automatically require equipment but still, allow an authorized user to alter the equipment requirement designation by selecting the equipment requirement tab 142. Also displayed is equipment tab 144 where a user can select to add equipment. Once the equipment has been selected, the type of equipment will be displayed in itemized equipment tab 146. Itemized equipment tab 146 may include the type of equipment selected, the number of equipment items selected by type, and or in total. The name of the user and the time stamp of when the equipment was selected may also be included. Furthermore, if an equipment item has a certain designation or equipment number this information may also be included under the equipment tab. To note when the equipment is picked up, a timestamp may also be displayed. There may also be an indicator that displays when all the ordered equipment has been picked up and or placed in the appropriate location. Also, as the equipment is ordered and picked up, task tracking tool 100 may automatically mark the task completed. The system may also require that the task only be marked complete when the equipment is placed in the appropriate room. Sensors may be placed on the equipment that communicates with the task tracking tool 100 indicating the location of the tool to complete a required task. Furthermore, an image or video of the equipment may be uploaded for proof that the equipment items have been taken to a worksite and that they are placed in the appropriate room/area. This may also help to show the condition of the equipment when it is picked up in the event that damage occurs during the use of the equipment and mitigation of the damage. The uploaded photographs may also be designated as a required task.

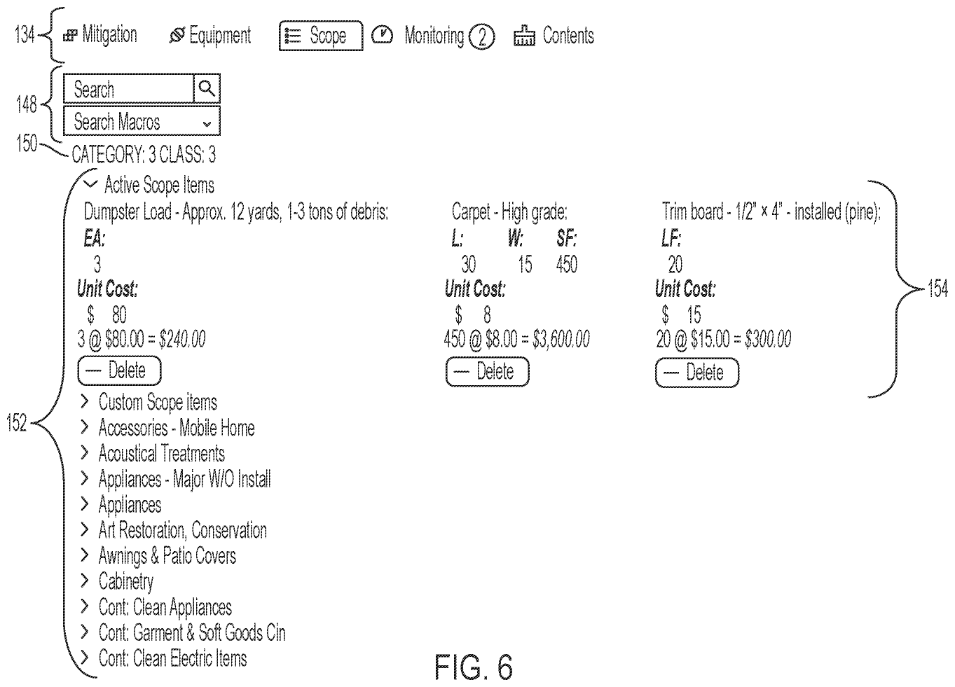

FIG. 6 illustrates an example of a user interface of a task tracking tool, according to an embodiment of the disclosure. Task tracking tool 100 may also display the mitigation scope when selected. Mitigation scope may aid in calculating the costs of repairing damage and may allow the user to itemize expenses. When mitigation scope is selected, search bar 148 may be displayed to search through different scope categories. Macros search bar 150 may also be included. Macros search bar 150 may allow the user to search through different area/room categories. These categories have lists of different expenses that often occur during the course of doing a particular task or project, using a particular piece of equipment, or working in a specific room or area. When using the search bar 148, the user may type in or scroll through a list of different pieces of equipment, task, and rooms/areas. The different pieces of equipment, task, and rooms/areas may be altered or narrowed according to the category and class of the damage done. A category and class may affect the options which are selectable or searchable in the macro search bar 150. For example, water damage may be considered category 3 class 3. A category designation may indicate a level of water contamination while a class designation may identify a probable rate of evaporation. This may mean that category 3 damage includes black water that is grossly unsanitary (e.g. sewage). Class 3 may describe the amount of water at a certain location. There also may be different classes to describe other house damage such as a fire or earthquake. Alternatively, depending on whether the project is to be completed, other categories may be provided. For example, if task tracking tool 100 is being used for event planning, there may be a category for the size or type of activity. These macros may contain event choices like weddings, mariachi bands, and cake making. These macros may identify constant or usual tasks for a particular activity that would be common to all events of the type regardless of how it is implemented.

When a certain task/project is selected a list of tasks or subtasks that may be included are displayed as task list 152 as a macro, associated with the task/project. These different tasks or subtasks may be selected among the options presented. Once the applicable task or subtasks are selected, a list of potential costs is displayed in material display 154. A user may input a quantity of a certain item, the unit cost, and the total cost for accounting records, for example. For instance, if a dumpster is required for projects of this type, the dumpster may be included as a task associated with the macro and the user may provide an estimated number of dumpster loads required to remove debris and a cost associated with such removal on a dumpster load by dumpster load basis. The price of each dumpster load and the total cost for the number of loads may be calculated by task tracking tool 100. This process may be repeated for other equipment or materials (e.g. carpet, trim board). Total cost may be included according to task, equipment, and/or area/room. The cost amount may also be listed as a total amount. These different items may also be expressed in terms of any units, such as dollars, board feet, dumpster square feet, and any other relevant unit.

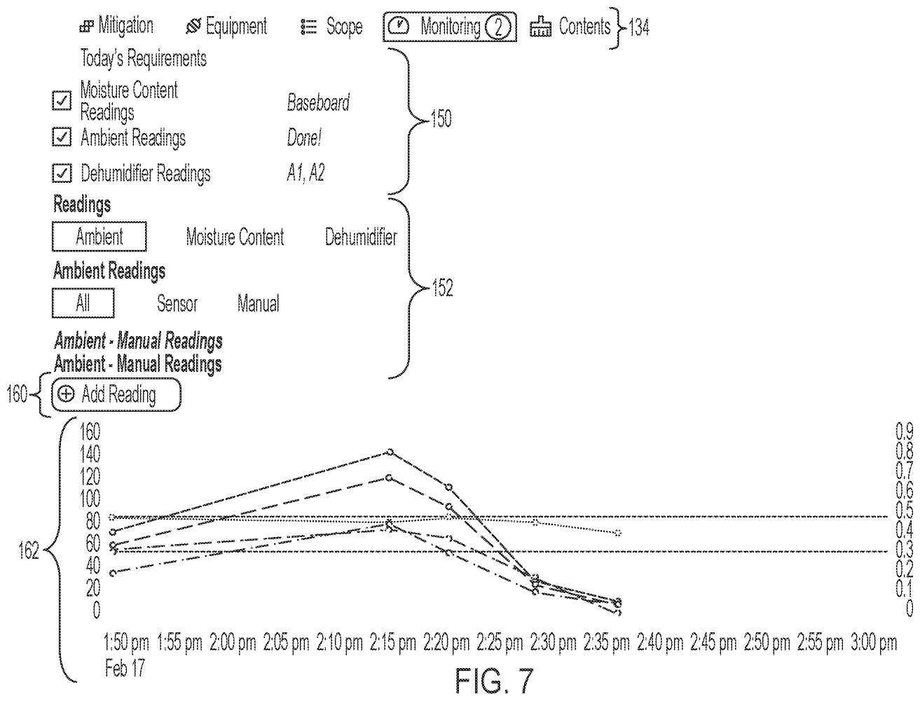

FIG. 7 illustrates an example of a user interface of a task tracking tool, according to an embodiment of the disclosure. Task tracking tool 100 may also display monitoring (such as moisture monitoring) on room menu 134. Monitoring may be selected, and tasks may be displayed as monitoring tasks 150. Monitoring tasks 150 may display the tasks required prior to the completion of a project. The tasks may include a checkmark or some sign of completion. Monitoring tasks 150 may further include notes to indicate where the reading was taken, which sensors were used, and any notes concerning the process. Under readings tab 152 different types of readings may be displayed (e.g., ambient, moisture content, dehumidifier, and other equipment or sensors known in the art). Each of the types of readings may be selected to display their respective outputs. After selecting what type of reading is necessary under readings tab 152 the input type may be selected whether the reading was input directly by the sensor or manually by the user. Add reading tab 160 may also be included to manually input an additional reading or to connect another sensor. Graphical representations of the readings may be displayed under graph 162. If another type of reading is selected under readings tab 152 a different graph may be displayed under graph 162 depicting the reading based on the new selection. Graph 162 represents the different readings over time. Other types of graphs may be used to show the data received.

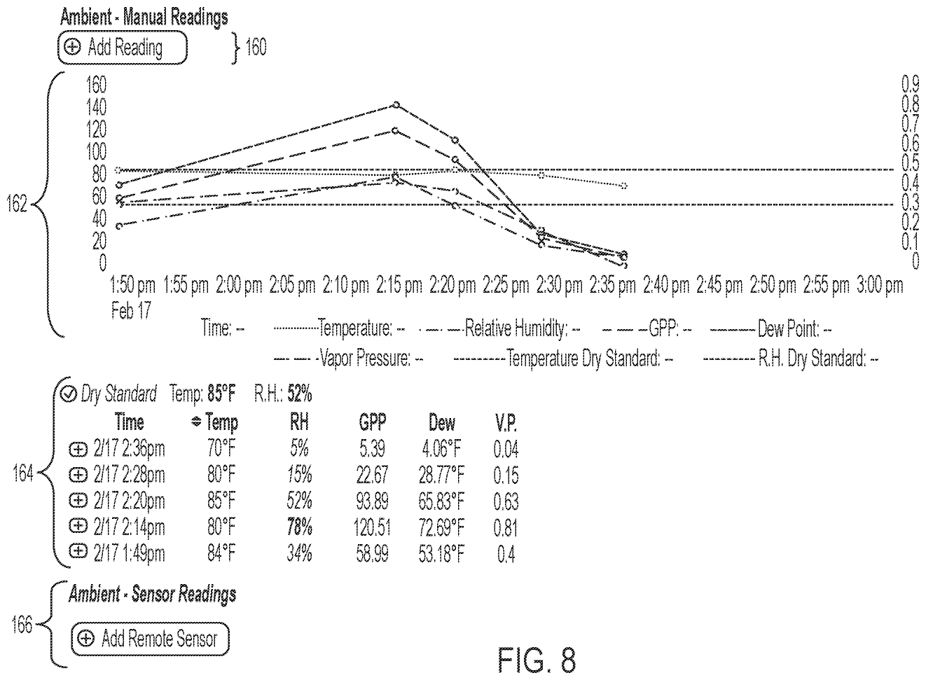

FIG. 8 illustrates an example of a user interface of a task tracking tool, according to an embodiment of the disclosure. Further, graph 162 may display multiple measurements simultaneously on the same graph. One or more of the data points can be calculated manually. For example, a user may select to add reading tab 160 and input a temperature and relative humidity, and a dew point, GPP (grains per pound of dry air to measure the water vapor in the environment), and vapor pressure may be calculated by task tracking tool 100. One or more of these data points may be included in graph 162. The user may select one or more of the data points to be displayed on the graph. Data points may be displayed numerically under data point table 164. The data point table 164 may display the readings of one or more manually input, sensor input, or calculated input data points. Also, a remote sensor may be added by selecting add remote sensor tab 166.

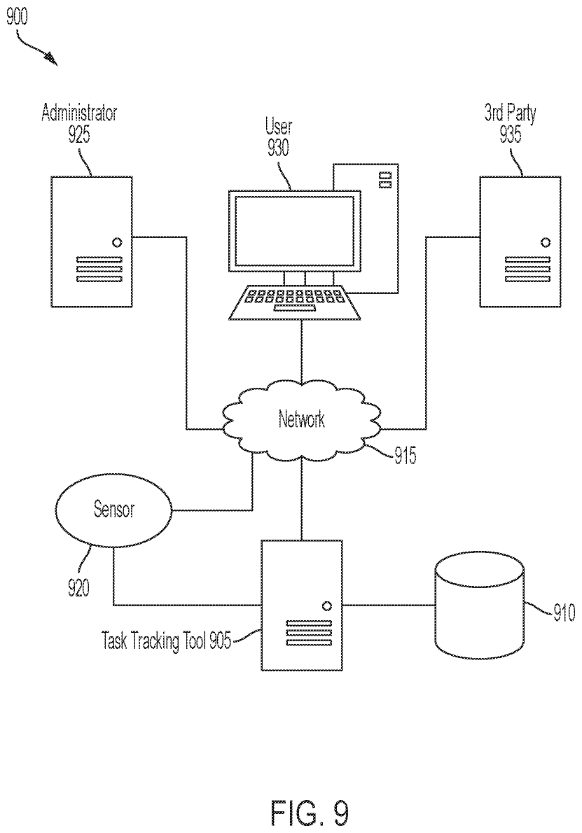

FIG. 9 illustrates a schematic diagram of system 900 for task tracking. In an embodiment, the system 900 includes a task tracking tool 905 with an associated database 910. Database 910 is configured to store data relating to task tracking tool 905, including data received from other sources, such as sensor data, and data relating to rules, settings, and intelligence sources for tracking workflow or projects. The task tracking tool 905 is in communication with an administrator 925, a consumer 930, and one or more third parties 935 over a network 915. The task tracking tool 905 is further in communication with one or more sensors 920.

Administrator 925 is an account associated with a provider of goods and/or services. The person and/or entity associated with the administrator 925 account may be, for example, an entity that provides goods or services, an employee, an independent contractor, a manager, an organization, a retailer, a professional, a nonprofit organization, and so forth. The administrator 925 may include a computing system and/or server in communication with the person or entity associated with the account. Administrator 925 may communicate with the task tracking tool 905 over network 915. The administrator 925 may communicate inputs received from the person/entity associated with the account to the task tracking tool 905 and such inputs may be consumed and processed to provide dynamic and real-time tracking of a workflow process.

The user 930 is an account associated with a person and/or entity that is receiving a good or service from the person/entity associated with the administrator 925. The user 930 may be a computing resource and/or server that is in communication with the task tracking tool 905 by way of the network 915 and receives inputs from a consumer person or entity (e.g., a web-based application, a mobile application, or any other electronic communication). The user 930 may provide information, updates, contracts, forms, and so forth to the person/entity associated with the user 930 account. Further, the user 930 may receive updates, for example, electronic signatures, form inputs, personal information, and so forth, from the person/entity associated with the user 930 account.

The third party 935 is an account associated with a person and/or entity that is a third party to a transaction occurring between the persons/entities associated with the administrator 925 and user 930 accounts. In an embodiment, the third party 935 is a computing resource and/or server that is in communication with the task tracking tool 905 by way of the network 915 and receives inputs from a third-party person or entity by way of, for example, a web-based application, a mobile application, or any other electronic communication. In various embodiments, the third-party person/entity includes, for example, an insurance company, an administrative agency, a research organization, and so forth.

The sensor 920 may be any suitable sensor relevant to the workflow or project and may be in communication with the task tracking tool 905 directly or by way of a network 915 such as a cloud computing network. The sensor 920 may provide sensor data to the task tracking tool 905 that may be automatically analyzed, by one or more processors, and assessed to determine if one or more items in the workflow or project are complete or progressing. Then one or more processors may generate a progress report that may include an estimated time of completion. The sensor 920 data may be forwarded to one or more of the providers' 106 accounts, the third-party 935 accounts, or the user 930 account by the task tracking tool 905. The sensor 920 data may be stored in the database 910 long-term such that it is categorized and may be analyzed and retrieved even after a workflow or project or task is closed.

For example, in an implementation where the workflow or project concerns a flood repair service, the sensor 920 may include a moisture sensor that provides a reading on the current state of moisture at a location. Further, the sensor 920 may include a camera that may automatically or manually capture images of a location producing picture data. Additionally, the sensor 920 may produce data that is stored in a non-transitory readable storage medium and a task completion notification may be sent out in response to storing the sensory input data. The sensor 920 may further include a reading from one or more pieces of equipment indicating, for example, whether the equipment is functioning properly, how long the equipment has been utilized, an estimated lifetime for the equipment, whether the equipment requires additional fuel, where the equipment is located and so forth.

It should be appreciated the workflow or project may be directed to any suitable industry, including any suitable service-based industry. Various workflows or projects may have different workflow items or tasks relevant to the particular job and/or industry. Further, various sensors are applicable to varying industries and it should be appreciated that any suitable sensor may be utilized in accordance with the present disclosure.

The task tracking tool 905 may be in communication with the administrator 925, the third party 935, and the user 930 by way of the network 915. The task tracking tool 905, in one embodiment, is a web-based application and/or a mobile device application. In an embodiment, the task tracking tool 905 is cloud-based and may be accessed by any of the administrator 925, the third party 935, and/or the user 930 at any given time. The task tracking tool 905 serves to provide dynamic and real-time information concerning a workflow for a good, service, marketing campaign, or other product.

The task tracking tool 905 may automatically generate a workflow or project and auto-populate the workflow or project with one or more workflow items or tasks. Workflow items or tasks include, for example, a task to be completed, a sensor reading to be determined, a work order agreement to be generated, a work order agreement to be signed, a threshold sensor reading to be reached, a threshold time of working to be reached, a final product to be generated or provided, and so forth. In various embodiments the workflow items or tasks may be manually input by a user associated with any of the administrator 925, the third party 935, or the user 930. Further, the workflow items or tasks may be automatically generated according to predefined rules or task completion requirements set by, for example, the administrator 925. Further, the workflow items or tasks may be automatically generated according to one or more inputs received from an account. For example, an account may indicate to task tracking tool 905 that a workflow or projects should be generated for a particular job type. The task tracking tool 905 may then automatically generate one or more workflow items or tasks to be completed according to predefined rules or task completion requirements for that particular job type.

The task tracking tool 905 utilizes inputs received from any user including the administrator 925, the third party 935, the user 930, and/or the sensor 920 to indicate a real-time status update for a project. In an embodiment, the task tracking tool 905 merges data, including sensor input data, received from the administrator 925, the third party 935, and the user 930 to provide a comprehensive real-time status report for all of the relevant workflow or project. In an embodiment, the task tracking tool 905 does not receive data from every account associated with the workflow or project, (e.g. the administrator 925, the user 930, and the third party 935) but may permit all relevant accounts to view data relevant to the workflow or project. In an embodiment, the task tracking tool 905 generates individualized Moisture Content Readings Ambient

### Readings Dehumidifier Reading

for different accounts. The individualized reports may provide certain data and hide other data from view for a particular account. In an embodiment, the task tracking tool 905 generates multiple reports for a single account (e.g. the administrator 925, user 930, and/or third party 935) and each of the multiple reports is specialized for a particular user associated with that account. For example, a manager associated with the administrator 925 account may have different permissions rules and may be permitted to view more information than an independent contractor associated with the administrator 925 account.

The task tracking tool 905 may update data for one or more workflow items or tasks according to inputs received from any of the administrator 925, the third party 935, the user 930, or the sensor 920. Further, the task tracking tool 905 may generate one or more messages to be transmitted based on any status update to the workflow or project. In an embodiment, the task tracking tool 905 automatically updates a user's 930 account when a threshold sensor reading has been reached, for example. Further, for example, task tracking tool 905 automatically updates a management account associated with administrator 925 when, for example, an employee account associated with administrator 925 has checked in or begins working on a workflow item or task.

In a particular embodiment, the task tracking tool 905 particularly provides real-time workflow tracking for a flood repair service as particularly illustrated in the workflow diagrams as illustrated in FIGS. 1-8. It should be appreciated that the task tracking tool 905 may be applied to any suitable good, service, marketing campaign, and so forth, and is not restricted to the application of a flood repair service workflow.

Implementations of the systems, devices, and methods disclosed herein may comprise or utilize a special-purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general-purpose or special-purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general-purpose or special-purpose computer. Combinations of the above should also be included within the scope of computer-readable media.

Computer-executable instructions comprise, for example, instructions and data which when executed at a processor, cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, televisions, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

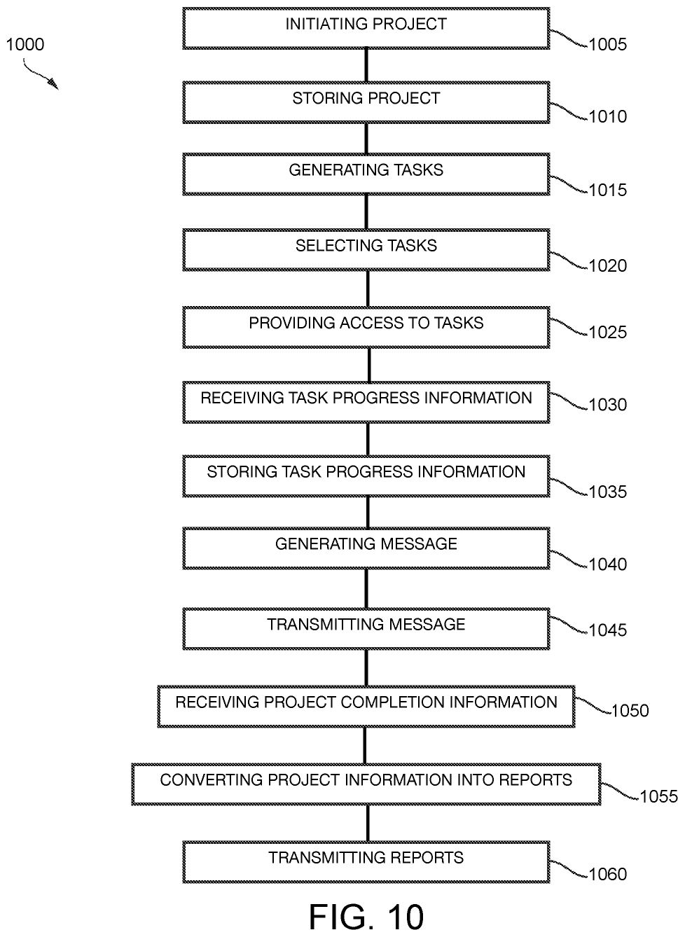

FIG. 10 illustrates an example of a method which steps may be executed by a processor and used in conjunction with task tracking tool 1000. This method may include the above-described action in FIGS. 1-9 within one or more steps of the method of task tracking tool 1000. Further, the exemplary method may be used in remediation repair in a home or other building. At the same time, these same steps can be used for building a house or an addition, building a road, restoring a vehicle, or any other multistep and/or multi-person project.

Step 1005 of initiating the project may include logging in to a user interface and setting up passwords, business logos, addresses, authorized users, email passwords, etc. Once a business and its authorized, a processor may request a user set up step 1005 and may identify a project to include a description of a particular project. This may include identifying what damage remediation scope of the project may be, what caused the damage, where the project is located including an address and/or where on the property is the damage located, who the owners of the relevant property are, insurance information, and the year was the home constructed. The architectural layout of the property and the percentage of the property damaged may also be included in initiating the project. At information input step 1010 the processor may cause the system to store information received from the user in step 1005. Then in step 1015, a processor associated with task tracking tool 1000, may generate a list of tasks based on the information input from step 1005. The tasks generated in step 1015 may include warnings of the possible presence of asbestos and/or lead paint that may require an additional protocol to satisfy federal and state rules and regulations. These tasks are transmitted from the task tracking tool system based on processor instructions and may be displayed on a device associated with an authorized user. Among these tasks, the most common tasks may be pre-selected by a user of task tracking tool 1000. In step 1020 an authorized user may cause the processor to remove one or more tasks from the scheduled task list. This may be actuated by selecting a box to add or remove a checkmark or to activate or deactivate a toggle switch.

In step 1025 the selection of tasks by the authorized user may be saved to the system memory by the processor. After being saved the selected tasks may be distributed by the processor to the appropriate user. For example, if the project requires subcontractors such as a plumber and a finish carpenter, a plumber may receive tasks from the task tracking tool system processor which are associated with the plumber while the finish carpenter will receive the tasks from the task tracking tool system processor associated with the finish carpenter. In this example, the plumber's device may receive the plumber tasks that may require completion before the finish carpenter replaces the crown molding, for example. In step 1025, the processor of task tracking tool 1000 may automatically send the appropriate task to the appropriate user. Further, the user, owner, or authorized user may also view the tasks to be completed through the task tracking tool system user interface. In step 1030, each user assigned a task having access to task tracking tool 1000 may update the progress of their assigned task. Further, an authorized user, in addition to a user assigned the task, may also update task progress. The progress information received in step 1030 may be stored within task tracking tool 1000 in step 1035.

In step 1040 a message task tracking tool 1000 may be created by the processor. In step 1045 the processor may cause this message may be transmitted to one or more users of task tracking tool 1000. Messages transmitted in step 1045 may be individualized. For example, the message to the plumber after completing the plumbing task may include “Congratulations your task is complete and may include a report of the task that may include time spent completing the task, equipment used, worker used” or similar message conveying intended information. However, the finish carpenter may receive a message that says “Your task is now available.” Since a task may be required to wait until another task is complete updates of the progress may help the worker schedule when to arrive at the project site. Further, the message may include a percentage of completion of the task. Accordingly, the finish carpenter may see that the plumber's task is 75% complete. Additionally, users may also receive a message generated by the processor in step 1045 indicating the percentage completed of a project.

In step 1050, a processor associated with task tracking tool 1000 receives the completion of the last required task and saves all the information provided in the completion of each task. This project information is then converted into reports in step 1055 including sensor information, images, graphs, notes, etc. For example, an insurance company may be a user of task tracking tool 1000 and may require certain information including before and after pictures and detailed descriptions of the repairs that took place including equipment and materials. Accordingly, in step 1055, a processor associated with task tracking tool 1000 groups all information required or indicated by an authorized user and places them into a report. Different reports may be produced for different users. For example, each subcontractor may receive their own report. The project manager may receive a more comprehensive report detailing the work of the subcontractors. Once the converted information is converted into one or more reports in step 1055 reports are transmitted to the appropriate user in step 1060. The project manager may receive all reports.

An example of implementation may include a task tracking method comprising: storing, by a processor, information in a standardized format about a project and the tasks required to complete the project in a plurality of network-based non-transitory storage devices having a collection of projects stored thereon; providing, by a processor, remote access to users over a network so any one of the users can update the information about the project's progression in real time through a graphical user interface, wherein the one of the users provides the updated information on the hardware and software platform used by the one of the users; storing, by the processor, the updated information about the project's progression in the collection of projects in a memory device; automatically generating a message, by the processor, containing the updated information about the project by the content server whenever updated information has been stored; transmitting, by the processor, the message to one or more select users over the computer network in real time, the one or more select users has immediate access to up-to-date project information; and converting by a processor associated with a server, upon completion of the project, the collected information into a report including one or more sensor information.

While various embodiments of the present disclosure have been described above, it should be understood that they have been presented by way of example only, and not by limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A task tracking method comprising:
receiving, by a processor, a request to initiate a project along with information about the type of project;
generating, by the processor, suggested tasks according to the type of project initiated;
receiving, by the processor, acceptance or denial of the suggested tasks;
storing, by the processor, information about a project and the tasks required to complete the project in a plurality of network-based non-transitory storage devices having a collection of projects stored thereon;
providing, by the processor, remote access to users over a network so any one of the users can update the information about the project's progression in real time through a graphical user interface, wherein the one of the users provides the updated information on a device associated with the user displaying the graphical user interface;
storing, by the processor, the updated information about the project's progression in the collection of projects in a memory device;
automatically generating, by the processor, a message containing the updated information about the project by the content server whenever updated information has been stored;
transmitting, by the processor, the message to one or more select users over the computer network in real time, the one or more select users has immediate access to up-to-date project information; and
converting, by the processor, by a content server the collected information into a report.

2. The task tracking method of claim 1, further comprises indicating by the graphical user interface whether or not a task has been preselected to be included in the project.

3. The task tracking method of claim 2, further comprises altering, by one of the one or more select users, the tasks using the graphical interface by adding one or more tasks not preselected or removing on deselecting one or more preselected tasks.

4. The task tracking method of claim 1, wherein generating suggested tasks includes generating a task requiring sensor input data.

5. The task tracking method of claim 4, further comprising generating a task requiring sensor input data that includes an image of a subject before initiation of the project.

6. The task tracking method of claim 4, further comprising generating a task requiring sensor input data that includes a temperature reading.

7. The task tracking method of claim 6, generating a dew point value upon receiving a sensor input data of a temperature reading.

8. The task tracking method of claim 1, wherein one or more of the reports includes data in a graphical representation.

9. The task tracking method of claim 1, wherein information about a project includes the geographic location of the project.

10. The task tracking method of claim 9, wherein the geographic location of the project is further divided into rooms.

11. The task tracking method of claim 10 wherein one or more project tasks is assigned to a specific room.

12. A task tracking device comprising:
a processor to:
receive a request to initiate a new project including information about the type of project;
generate suggested tasks according to the type of project initiated;
receive acceptance or denial of the suggested tasks;
store information about a project and the tasks required to complete the project in a plurality of network-based non-transitory storage devices having a collection of projects stored thereon;
provide remote access to users over a network so any one of the users can update the information about the project's progression in real time through a graphical user interface, wherein the one of the users provides the updated information on a device associated with the user displaying the graphical user interface;
store the updated information about the project's progression in the collection of projects;
automatically generate a message containing the updated information about the project by the processor whenever updated information has been stored;
transmit the message to one or more select users over the computer network in real time, the one or more select users has immediate access to up-to-date project information; and
convert, by the processor, project data including the updated information about the project's progression into a report.

13. The task tracking method of claim 12, further comprises indicating by the graphical user interface whether or not a task has been preselected to be included in the project.

14. The task tracking method of claim 13, further comprises altering, by one of the one or more select users, the tasks using the graphical interface by adding one or more tasks not preselected or removing on deselecting one or more preselected tasks.

15. The task tracking method of claim 12, wherein generating suggested tasks includes generating a task requiring sensor input data.

16. The task tracking method of claim 15, further comprising generating a task requiring sensor input data that includes an image of the subject before initiation of the project.

17. A task tracking system comprising:
a camera;
a processor configured to:
receive a request to initiate a new project including information about the type of project;
generate suggested tasks according to the type of project initiated;
receive acceptance or denial of the suggested tasks;
store information about a project and the tasks required to complete the project in a plurality of network-based non-transitory storage devices having a collection of projects stored thereon;
provide remote access to users over a network so any one of the users can update the information about the project's progression in real time through a graphical user interface, wherein the one of the users provides the updated information on a device associated with the user displaying the graphical user interface;
store the updated information about the project's progression in the collection of projects;
automatically generate a message containing the updated information about the project by the processor whenever updated information has been stored;
transmit the message to one or more select users over the computer network in real time, the one or more select users has immediate access to up-to-date project information; and
convert, by the processor, project data including the updated information about the project's progression into a report.

18. The task tracking method of claim 17, further comprises indicating by the graphical user interface whether or not a task has been preselected to be included in the project.

19. The task tracking method of claim 18, further comprises altering, by one of the one or more select users, the tasks using the graphical interface by adding one or more tasks not preselected or removing on deselecting one or more preselected tasks.

20. The task tracking method of claim 12, wherein generating suggested tasks includes generating a task requiring sensor input data from the camera.
